(19) United States
(12) Patent Application Publication
(10) Pub. No.: US 2009/0103043 A1
(43) Pub. Date: Apr. 23, 2009

(54) EYEGLASS RETAINING DEVICE

(76) Inventor: Roger Alan Ramsey, Hillsboro, OR (US)

Correspondence Address: GANZ LAW, P.C., P O BOX 2200, HILLSBORO, OR, 97123, US

(21) Appl. No.: 12/253,628

(22) Filed: Oct. 17, 2008

Related U.S. Application Data
(60) Provisional application No. 60/981,443, filed on Oct. 19, 2007.

(51) Int. Cl. G02C 3/02

(52) U.S. Cl. 351/155

(57) ABSTRACT

A retaining device for retaining eyeglasses on headgear while covering the head of a person, including at least one tethering element for holding the temples of an eyeglass frame and at least one retaining element coupled to the tethering element. The retaining element is adapted to hold the tethering element together with the eyeglasses to the head of a person, so that the eyeglasses may be repositioned from a first position in front of the eyes to a second tensioned position against the person's head in which the eyeglasses are not in use and prevent the eyeglasses from falling down, and wherein the retaining element is adapted to attach the tethering element to headgear. In one possible embodiment, the retaining element is adapted to attach the tethering element to a cap or hat, for example.

### RELATED APPLICATIONS

This application claims the benefit of and priority to U.S. Provisional Application Ser. No. 60/981,443, filed Oct. 19, 2007 the contents of which is hereby incorporated by reference as if recited in full herein for all purposes.

### BACKGROUND

The inventive subject matter disclosed herein is directed to means for retaining and supporting eyeglasses on a wearer's head.

Glasses, also called eyeglasses or spectacles, are frames bearing lenses, worn in front of the eyes normally for vision correction, eye protection, or for protection from UV rays. Eyeglasses are typically supported by pads on the bridge of the nose and by arms or temples placed over the ears.

People may wear glasses for several reasons. Safety eyeglasses are worn by many individuals in the trades to protect there eyes from projected air born matter. People wear tinted eyeglasses to protect from bright conditions that strain the eyes and could damage them from overexposure. Magnifying or reading eyeglasses are worn by people who are farsighted. In most cases, the people with the needs described above only desire to wear eyeglasses when conditions require the need and they remove them when they are not in need. At the same time many of these same people wear some type of cap or hat to shade the eyes and add further protection. There are numerous people who find it convenient to rest the lenses of their eyeglasses on top of their visors while the arms or temples of the eyeglasses rest along the sides of the cap above the person's ears. From this convenient position, eyeglasses may easily fall and break.

Many devices have been developed to retain eyeglasses on a person's head and/or a hat while the eyeglasses are not in use. None of the prior art designs, however, provides ease of operation, efficiency of movement, and versatility.

Accordingly there is a need for improved devices that address these needs.

### SUMMARY

The inventive subject matter offers a solution for these problems by providing eyeglass retaining devices with the following qualities, alone or in combination.

The inventive subject matter is directed to a device for retaining eyeglasses on headgear while covering the head of a person. In one possible embodiment, the device includes at least one tethering element for holding the temples of an eyeglass frame; at least one retaining element coupled to the tethering element; and the retaining element adapted to hold the tethering element together with the eyeglasses to the head of a person, such that the eyeglasses may be repositioned from a first position in front of the eyes to a second tensioned position against the person's head in which the eyeglasses are not in use and prevent the eyeglasses from falling down, and wherein the retaining device is adapted to attach the tethering element to headgear. In the foregoing embodiment, the retaining element may be adapted to attach the tethering element to a hat so that the lenses of the eyeglasses are supported on the rim of the hat. In the foregoing embodiment, the tethering element may be attached to a cap, so that the lenses of the eyeglasses are supported on the visors of the cap. In the foregoing embodiment, the tethering element and retaining element may form an integrated one-piece structure. In the foregoing embodiment, the tethering element may have a tethering loop.

In the foregoing embodiment, the tethering element may include a retractable reel. In the foregoing embodiment, the tethering element may include a flexible material and/or an elastic material. In the foregoing embodiment, the retaining device may further include a support element to rest the temples of an eyeglass frame on. In the foregoing embodiment, the tethering element, support element, and retaining element may be formed as an integrated one-piece structure.

In another possible embodiment, the inventive subject matter is directed to a set of retaining devices for retaining eyeglasses on a cap covering the head of a person, and includes a left tethering element attachable to the left temple of an eyeglass frame; a right tethering element attachable to the right temple of an eyeglass frame; a left retaining element adapted to couple the left tethering element to the left side of the cap; a right retaining element adapted to couple the right tethering element to the right side of the cap; the combination of left and right tethering elements and left and right retaining elements holding the eyeglasses to the head of a person so that the eyeglasses may be repositioned from a first position wherein the lenses of the eyeglasses are in front of the eyes and the temples are anchored behind the ears, to a second tensioned position wherein the lenses and frames rest on the visor of a cap and the temples rest along the sides of the cap above the person's ears, and the retaining elements prevent the eyeglasses from falling down. In the foregoing embodiment, the retaining device may further include left and right support elements for supporting the temples of the eyeglass frame. In the foregoing embodiment, the tethering elements, the retaining elements, and the support elements may form an integrated one-piece structure adapted to retain the left and right temples of eyeglasses to a cap on the head of a person. In another possible embodiment, the inventive subject matter may include a kit including a cap; and at least one of the inventive retaining devices for retaining eyeglasses on the cap. The inventive subject matter further contemplates a method for making and using a retaining device for retaining eyeglasses to the head of a person by providing at least one tethering element adapted to be coupled to the temples of an eyeglass frame; providing at least one retaining element coupled to the tethering element, and the retaining element adapted to be coupled to headgear so that the eyeglasses may be repositioned from a first position in front of the eyes, to a second tensioned position against the headgear and the person's head, in which the eyeglasses are not in use and prevent the eyeglasses from falling down. In the foregoing embodiment, the retaining device may be provided with a support element to rest the temples of an eyeglass frame on.

The inventive subject matter further contemplates a method for using a retaining device for retaining eyeglasses to the head of a person by coupling at least one tethering element to the temples of an eyeglass frame; coupling at least one retaining element to the tethering element, and coupling the retaining element to headgear so that the eyeglasses may be repositioned from a first position in front of the eyes, to a second tensioned position against the headgear and the person's head, in which the eyeglasses are not in use and prevent the eyeglasses from falling down.

These and other embodiments are described in more detail in the following detailed descriptions and the figures.

The foregoing is not intended to be an exhaustive list of embodiments and features of the inventive subject matter. Persons skilled in the art are capable of appreciating other embodiments and features from the following detailed description in conjunction with the drawings.

### BRIEF DESCRIPTION OF THE DRAWINGS

The following figures show embodiments according to the inventive subject matter, unless noted as showing prior art.

FIG. 1 shows a simplified view of a side profile of a person's head wearing a hat and eyeglasses attached to the hat by a retaining device.

FIG. 2 shows the embodiment of FIG. 1 as the person is repositioning the eyeglasses from a first position to a second position.

FIG. 3 shows the embodiment of FIGS. 1 and 2, where the eyeglasses are positioned on the visor of a cap and held in place with a retaining device.

FIG. 4 shows a detail of a retaining device such as may be used in FIGS. 1-3.

FIG. 5 shows a detail of another embodiment of a retaining device as may be used in FIGS. 1-3.

FIG. 6 shows a simplified view of a side profile of a person's head wearing a hat and eyeglasses attached to the hat by another embodiment of a retaining device.

FIG. 7 shows the embodiment of FIG. 6, as the person is repositioning the eyeglasses from a first position to a second position.

FIG. 8 shows the embodiment of FIGS. 6 and 7, where the eyeglasses are positioned on the visor of a cap and held in place with the retaining device.

FIG. 9 shows a detail of a retaining device for eyeglasses, such as used in FIGS. 6-8.

FIGS. 10A-D illustrate how a retaining device may be formed from a flat metal clip.

FIGS. 11A-C illustrate a retaining device may be formed of a wire clip.

FIG. 12 shows another embodiment of a retaining device for eyeglasses.

FIG. 13 shows a side view of another embodiment of a retaining device while attached to a cap on a person's head.

FIG. 14 shows a perspective view of the retaining device shown in FIG. 13.

FIG. 15 shows a front view of the retaining device of FIG. 13 while attached to eyeglasses.

FIG. 16 shows a back view of the retaining device of FIG. 15.

### DETAILED DESCRIPTION

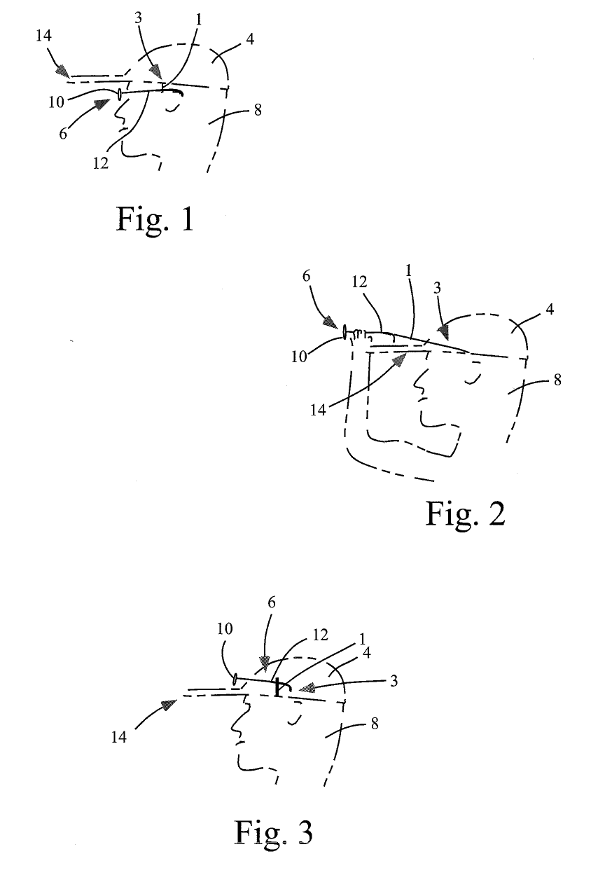

Representative embodiments according to the inventive subject matter are shown in FIGS. 1-16, wherein the same or generally similar features share common reference numerals.

The inventive subject matter is directed to novel devices for retaining eyeglasses on the head of a person. The retaining devices may attach eyeglasses to headgear, such as a hat to provide a convenient and secure way to store the eyeglasses when they are not being worn in the over-the-eye position.

The retaining devices include one or more a tethering elements for holding the temples of an eyeglass frame, and one or more retaining elements coupled to the tethering element to hold the eyeglasses to a person's head or cap. The retaining element is adapted to hold the tethering element together with the eyeglasses to the head of a person so that the eyeglasses may be repositioned from a first position, in front of the eyes, to a second tensioned position against the person's head, in which the eyeglasses are not in use, and prevent the eyeglasses from falling down. The retaining element may be adapted to attach the tethering element to headgear, such as a hat or a cap, and can be of any configuration which will firmly connect to the rim or hat band of a hat. Caps have crowns that fit closer than hats and have no brim or only a visor. They are typically designed for warmth and, when including a visor, blocking the eyes from the sun. Other examples of headgear that may use a retaining device for eyeglasses may include bicycle helmets or ski hats having a visor. The retaining device may be adapted to attach a tethering element, together with the eyeglasses, to a hat so that the lenses of the eyeglasses are supported on the rim of the hat or visors of a cap, for example, and are prevented from falling down when the person moves the head. The temples of the eyeglasses may rest along the sides of the cap above the person's ears.

In the embodiments described below, a retaining device 3 is provided with two tethering elements 1, namely a left tethering element coupleable to the left temple of an eyeglass frame, and a right tethering element coupleable to the right temple of an eyeglass frame. A left and right retaining element 2 is adapted to attach the respective tethering elements 1 at the left and right sides of the cap 4.

FIGS. 1-3 demonstrate the general operation of one possible embodiment of the inventive subject matter. The retaining device 3 holds the eyeglasses 6 attached to the sides of a cap covering the head 8 of a person. The eyeglasses 6 may be repositioned from a first position, as shown in FIG. 1, to a second position, as shown in FIG. 3. In the first position, the lenses 10 of the eyeglasses 6 are in front of the eyes of the person and the temples 12 are anchored behind the ears. Temples 12 are further coupled to retaining device 3. In the second position, the lenses 10 rest on the visor 14 of a cap 4, and retaining element 2 prevents the eyeglasses from falling down. FIG. 2 illustrates how a person wearing the cap may move eyeglasses 6 from a first position to a second position.

In other possible embodiments, the retaining device may attach to the rim of a hat or a hat band.

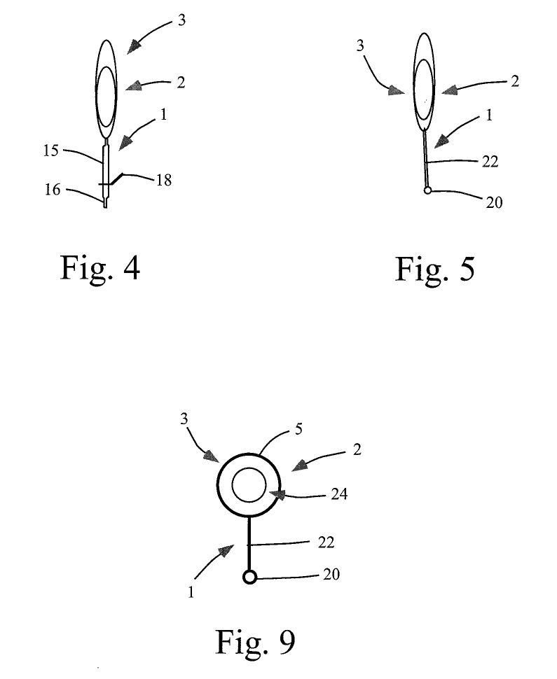

In one possible embodiment, tethering element 1 tethers the eyeglasses to the head or headgear by using a stretchable material or a mechanical system that tensions the eyeglasses against the head or headgear when placed in a position as shown in FIG. 3. In certain embodiments, tethering element 1 may have an adjustable element made of a rubber-like material or any other elastic material that allows stretching of the tethering element, to move the attached eyeglasses from the first position to the second position, while keeping the eyeglasses in place on the headgear. For example, tethering element 1, may be made from elastic cloth, band, or other elastic or stretchy material. For example, FIG. 4 shows a tethering element having an elastic loop 16, coupled to a cinch ring 16. Cinch ring 16 may have a cinch ring handle 18 coupled to loop 15 so that handle 18 cinches down onto the temple of the eyeglasses to secure the temples to tethering element 1. Handle 18 provides a simple and efficient mechanism to loosen the hold on the temples.

In other embodiments, tethering element 1 may include springs, such as those made of coiled metal or plastic.

FIG. 5 illustrates another embodiment of a retaining device 3 having a tethering element 1. Tethering element 1 has a tethering loop 20 and a stretchable band 22 coupled to retaining element 2. Tethering element 1 further may have a cylindrical element or cinch ring attached to band 22, to adjust the opening of tethering loop 20 and thereby adjust the tension provided to hold the temples of the eyeglasses. In certain embodiments, the tethering element and retaining element may be formed as separate pieces, while in other embodiments the tethering element and retaining element may be formed as an integrated one-piece or multi-piece structure.

In another possible embodiment, the inventive subject matter further includes a support element to support the temples of the eyeglasses. Examples of retaining devices having support elements are shown in FIGS. 9 and 13-16. FIG. 9 shows a retaining device 3 having a support element 5 and retaining element 2 integrated into one piece. Support element 5 may have the form of a nodule or a coupling for receiving the temples and engaging them in a frictional relationship or a removably attached relationship. Examples of support elements 5 for a removably attached relationship include clips, snaps, or other fasteners that would engage the temples or complementary elements placed on the temples. FIG. 9 shows a nodule 24 which will be exposed on the exterior side of the rim of a cap. Nodule 24 may be coated with a grippy rubber or elastic material that provides frictional engagement to frictionally engage the temples and helps keep them in place. Nodule 24 is round, but other shapes may be used. Nodule 24 may be connected to a tethering element 1, such as band 22. The tethering element has a loop 20 for receiving a temple of eyeglasses. FIG. 9 shows a tethering loop 20 hanging down without holding the temples of the eyeglasses. A left and right retaining device would respectively have left and right support elements for supporting the temples of the eyeglass frame on the left and right side of the head.

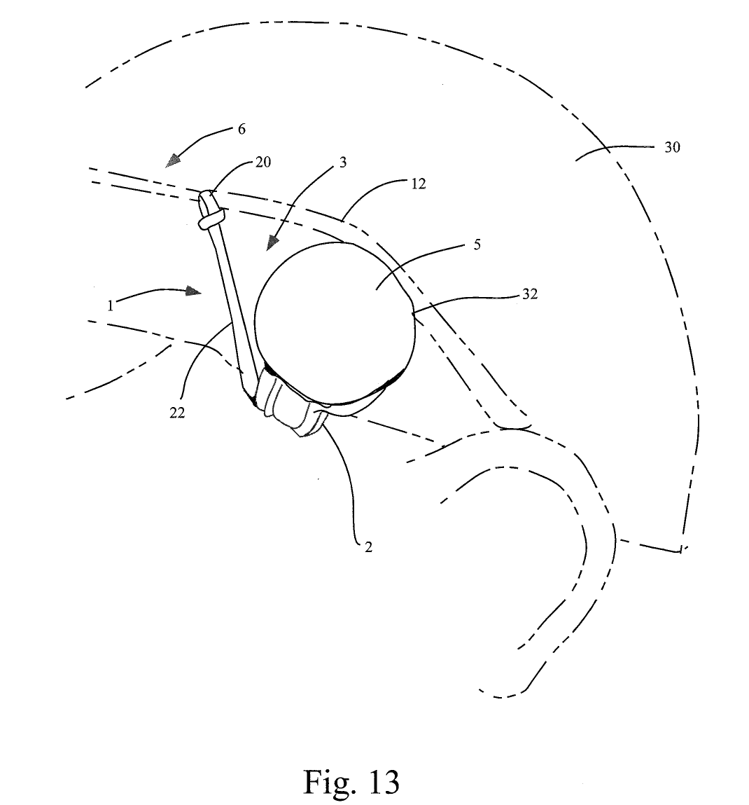

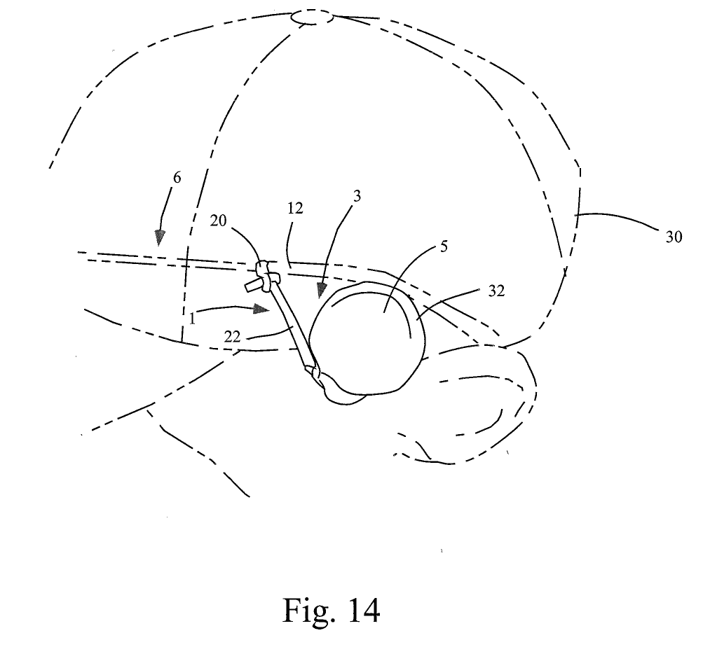

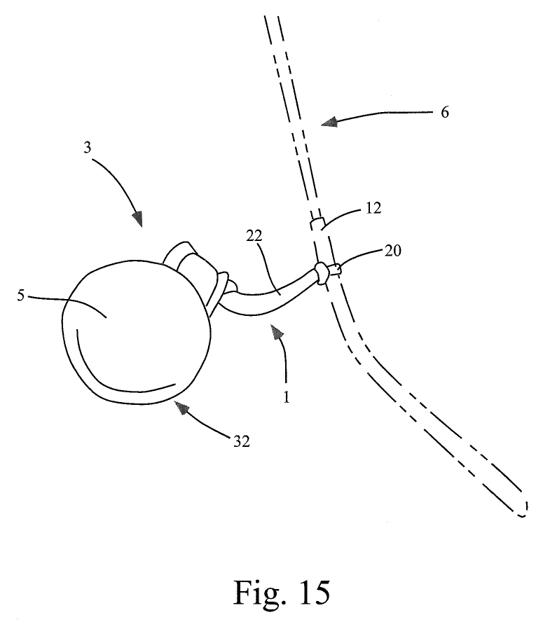

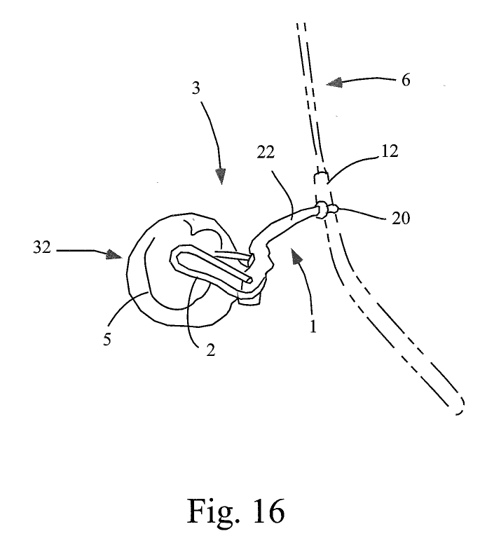

FIGS. 13-16 illustrate another possible embodiment of a retaining device 3 having a support element 5, similar to the retaining device shown in FIG. 9. FIGS. 13-14 show how retaining device 3 is attached to a baseball cap 30 while being on a person's head holding the eyeglasses in a tensioned position. FIG. 16 shows a support element 5 attached to retaining element 2 and tethering element 1. One end of tethering element 1 is attached to support element 5, while the other end of tethering element 1 is attached to temples 12 of eyeglasses 6. Tethering element 1 tensions the temples 12 on the baseball cap. FIG. 14 shows how a rim 32 of support element 5 supports temples 12. FIG. 15 shows a front view of a support element 5 as the retaining device 3 is attached to a temple 12 of eyeglasses 6. Tethering element 1 may, for example, be formed of an elastic band 22 strapped around the temples or of an elastic band provided with a loop. The tethering element may be made from any suitable flexible material, such as an elastic material or elastomer, which can undergo temporary deformation and return to its previous size without permanent deformation. For example, a tethering element may include synthetic rubber or natural rubber.

To maintain a good grip on the temples of the eyeglasses, tethering loop 20 may be formed of a material that is less elastic than the material from which band 22 is made. For example, the tethering element may be formed by bonding to materials having different properties specific for the band or tethering loop. In another embodiment, the tethering loop may be formed of an elastic material having a core or filament formed of a material that is relatively less elastic than the surrounding material and the material of the band. This filamentous structure results in a tethering loop 20 having a different elasticity than the band 22, and provides for engagement of the temples. Optionally, the tethering loop may have a material embedded that is relatively less elastic than the remainder of tethering element 1.

The previously described material allows tethering loop 20 to stretch around common diameters of typical temples and firmly hold them. This allows tethering element 1 to be stretched without tethering loop 20 losing its grip on the eyeglasses. In other embodiments, the remainder of tethering element 1 may be composed entirely of rubber or other elastic material.

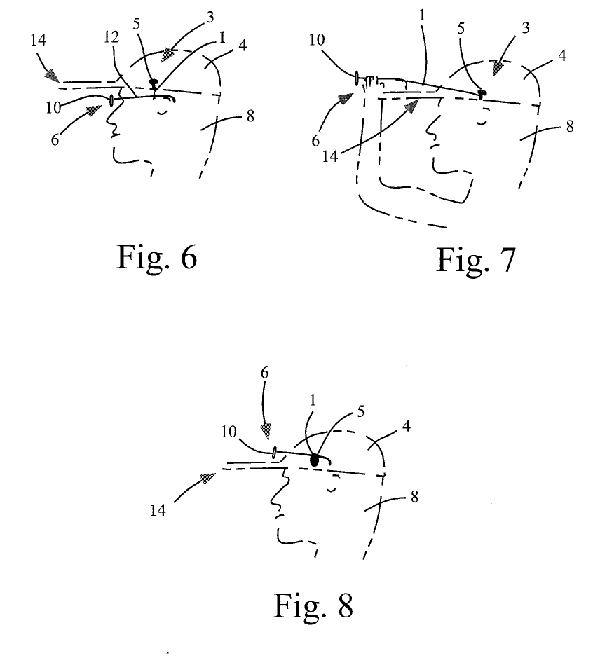

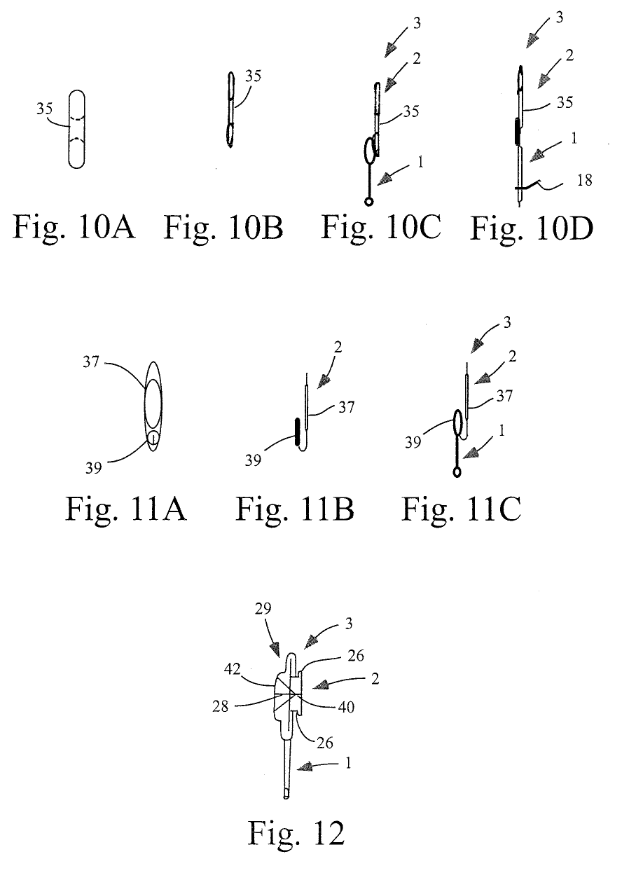

FIGS. 6-8 demonstrate the general operation of a retaining device 3 having a support element 5, as described above, for resting the temples of the eyeglasses on. FIG. 6 shows the optical retaining device 3 attached to eyeglasses 6 and a cap 4, with the wearer having eyeglasses 6 in the over-the-eye position. In this first position, retaining element 2 connects the eyeglasses to the hat 4 and allows eyeglasses 6 to rest upon the ears of the wearer. FIG. 7 illustrates how tethering element 1 may be extended to allow eyeglasses 6 to move around visor 14 of cap 4. In this transitional position, tethering element 1 is extended or stretched, requiring energy to maintain this position. Subsequently, eyeglasses 6 are positioned on visor 14. FIG. 8 shows optical retaining device 3 retracted back to a second position with eyeglasses 6 resting on visor 14 and the temples of eyeglasses 6 resting on top of support element 5 of the retaining device. In this position a slight strain is placed upon tethering element 1 which helps to hold the temples of the eyeglasses stationary.

In another possible embodiment, the inventive subject matter may use a retaining device 2 that allows a tethering element 1, such as band, cord, string, etc., to extend and retract automatically or manually. An example of such an embodiment would be a line that retracts onto a reel. As used herein a “reel” is an object around which lengths of another material, usually long and flexible, are wound for storage. Generally, a reel has a cylindrical core and walls on the sides to retain the material wound around the core. These types of retractable reels are commonly used to attach badges to clothing. A reel suitable for use in a retaining device may be smaller than a badge reel. Additionally, a reel may be coated in rubber to provide flexibility and cushioning. A retaining device using such a reel may look very similar to the retaining device illustrated in FIG. 9 and FIGS. 13-16, though instead of band 22 being made of rubber, it may be made of a non-stretching string that extends and retracts within a reel. The general operating procedures of such a retaining device having a reel are similar to the operations illustrated in FIGS. 6-8.

FIGS. 10A-D and FIGS. 11A-C further illustrate possible embodiments of a retaining device. FIGS. 10A-D illustrate how a retaining element may be formed from materials, such as a paper clip, flat metal clip, or other clipping means. FIGS. 10A-D show a retaining element in the form of a clip 35. FIG. 10C show a tethering element, such as described above with reference to FIG. 5, attached to clip 35. FIG. 10D shows a tethering element, as previously described with reference to FIG. 4, attached to clip 35.

FIGS. 11A-C shows a retaining device made from a wire clip 37 having a small button, knob, or disk-shaped element 39. For example, button 39 may have a coating of an elastic or rubber-like material. FIG. 11C shows a tethering element 1, as described above with reference to FIG. 9, attached to button 39. In other possible embodiments, retaining elements may be formed of any type of snaps, hook-and-loop fasteners, or fasteners, such as bankers clasps, magnetic fasteners, hair pins, etc.

FIG. 12 illustrates another possible embodiment of retaining device 3 wherein retaining element 2, in the form of a pin fastener 40, is surrounded by a layer 42, for example a layer of elastic material or rubber. This embodiment has the advantages of a support element 5 and a retaining element 2 integrated in one piece. In this embodiment, the retaining element 2 may be coated with rubber for protection and facilitate use of the retaining device. Pins 26 may prevent retaining element 2 from rotating around middle pin 28 which holds retaining element 2 on the head gear. Retaining element 2 has an upper part 29 to support the temples of the eyeglasses.

In another possible embodiment, the inventive subject matter may include an integrated one-piece structure including the tethering element, support element, and retaining element. In another possible embodiment, the tethering elements, the retaining elements, and the support elements are formed as an integrated one-piece structure and adapted to retain left and right temples of eyeglasses to a cap on the head of a person.

The inventive subject matter further contemplates a kit including a cap and at least one retaining device for retaining eyeglasses on the cap, a method for making such a retaining device, and a method for using such a retaining device.

Persons skilled in the art will recognize that many modifications and variations are possible in the details, materials, and arrangements of the parts and actions which have been described and illustrated in order to explain the nature of the inventive subject matter, and that such modifications and variations do not depart from the spirit and scope of the teachings and claims contained therein.

All patent and non-patent literature cited herein is hereby incorporated by references in its entirety for all purposes.

Currently claimed inventions:

1. A retaining device for retaining eyeglasses on headgear while covering the head of a person, comprising:
at least one tethering element for holding the temples of an eyeglass frame;
at least one retaining element coupled to the tethering element;
the retaining element adapted to hold the tethering element together with the eyeglasses to the head of a person, so that the eyeglasses may be repositioned from a first position in front of the eyes, to a second tensioned position against the person's head in which the eyeglasses are not in use and prevent the eyeglasses from falling down; and
the retaining element adapted to attach the tethering element to headgear.

2. The retaining device of claim 1, wherein the retaining element is adapted to attach the tethering element, together with the eyeglasses, to a hat so that the lenses of the eyeglasses are supported on the rim of the hat.

3. The retaining device of claim 1, wherein the retaining element is adapted to attach the tethering element to a cap, so that the lenses of the eyeglasses are supported on the visors of the cap.

4. The retaining device of claim 1, wherein the tethering element and retaining element form an integrated one-piece structure.

5. The retaining device of claim 1, wherein the tethering element comprises a tethering loop.

6. The retaining device of claim 1, wherein the tethering element comprises a retractable reel.

7. The retaining device of claim 1, wherein the tethering element comprises a flexible material.

8. The retaining device of claim 1, wherein the tethering element comprises an elastic material.

9. The retaining device of claim 1, further comprising a support element to rest the temples of an eyeglass frame on.

10. The retaining device of claim 9, wherein the tethering element, support element, and retaining element are formed as an integrated one-piece structure.

11. A set of retaining devices for retaining eyeglasses on a cap covering the head of a person, comprising:
a left tethering element attachable to the left temple of an eyeglass frame;
a right tethering element attachable to the right temple of an eyeglass frame;
a left retaining element adapted to couple the left tethering element to the left side of the cap;
a right retaining element adapted to couple the right tethering element to the right side of the cap;
the combination of tethering elements and retaining elements holding the eyeglasses to the head of a person so that the eyeglasses may be repositioned from a first position, wherein the lenses of the eyeglasses are in front of the eyes and the temples are anchored behind the ears, to a second tensioned position, wherein the lenses and frames rest on the visor of a cap and the temples rest along the sides of the cap above the person's ears, and the retaining elements prevent the eyeglasses from falling down.

12. The retaining device of claim 11, further comprising left and right support elements for supporting the temples of the eyeglass frame.

13. The retaining device of claim 12, wherein the tethering elements, the retaining elements, and the support elements are formed as an integrated one-piece structure adapted to retain the left and right temples of eyeglasses to a cap on the head of a person.

14. A kit comprising:
a cap; and
at least one retaining device for retaining eyeglasses on the cap.

15. A method for making a retaining device for retaining eyeglasses to headgear covering the head of a person, comprising:
providing at least one tethering element adapted to be coupled to the temples of an eyeglass frame;
providing at least one retaining element coupled to the tethering element, and the retaining element adapted to be coupled to headgear so that the eyeglasses may be repositioned from a first position in front of the eyes, to a second tensioned position against the headgear and the person's head, in which the eyeglasses are not in use and prevent the eyeglasses from falling down.

16. The method of claim 15, further comprising providing the retaining device with a support element to rest the temples of an eyeglass frame on.

17. A method for using a retaining device for retaining eyeglasses to headgear covering the head of a person, comprising:
coupling at least one tethering element to the temples of an eyeglass frame;
coupling at least one retaining element to the tethering element, and coupling the retaining element to headgear so that the eyeglasses may be repositioned from a first position in front of the eyes, to a second tensioned position against the headgear and the person's head, in which the eyeglasses are not in use and prevent the eyeglasses from falling down.
